(19) United States
(12) Patent Application Publication
(10) Pub. No.: US 2005/0071459 A1
(43) Pub. Date: Mar. 31, 2005

(54) System, apparatus, and method for providing media session descriptors

(76) Inventors: Jose Costa-Requena, Helsinki (FI); Ossi Korhonen, Vantaa (FI); Jussi Ruutu, Espoo (FI); Jukka Immonen, Espoo (FI); Markus Aholainen, Pirkkala (FI); Jari Selin, Helsinki (FI); Juha Hietasarka, Suinula (FI)

Correspondence Address: CRAWFORD MAUNU PLLC, Suite 390, 270 Northland Drive, St. Paul, MN, 55120, US

(21) Appl. No.: 10/672,941

(22) Filed: Sep. 26, 2003

(51) Int. Cl. G06F 15/16; G06F 15/173

(52) U.S. Cl. 709/224; 709/230

(57) ABSTRACT

A system, apparatus, and method is disclosed for providing media session descriptors. In accordance with one embodiment of the invention, a method of initiating a multimedia session via a computing arrangement involves forming a request for a session descriptor usable for initiating the multimedia session. The request is communicated to a session descriptor module of the computing arrangement. A session descriptor is formed based on a set of multimedia session parameters of the computing arrangement. The session descriptor is communicated from the session descriptor module, and the multimedia session is initiated using the session descriptor.

### FIELD OF THE INVENTION

This invention relates in general to multimedia services, and more particularly, to establishing multimedia sessions via computing arrangements.

### BACKGROUND OF THE INVENTION

Advances in communication infrastructures and protocols have turned computing devices into valuable communications tools. Computers communicate with each other, and with other electronic devices, over networks ranging from simple ad-hoc networks to wide reaching Global Area Networks (GANs) such as the Internet. In addition, wireless communications devices, such as mobile phones, Personal Digital Assistants (PDAs), and the like, have been increasingly designed to interface with these digital networks.

Today, such wireless devices are being used for a variety of different types of communication. For example, current technologies have created wireless devices that are powerful communication tools, capable of communicating voice, data, images, video, and other multimedia content. Mobile phones, at one time solely a voice communication tool, now often include network communication capabilities such as e-mail, World Wide Web browsing, etc.

With the integration of wireless and landline network infrastructures, a multitude of new services are arising, and various information types can be conveniently communicated between wireless and/or landline terminals. As a result, devices that access these services are dealing with a wide variety of network and communications protocols. A stack of emerging standards is being developed to deal with a wide array of rich digital content and to define the various protocols used to deliver that content.

In many cases, the protocols are implemented piecemeal, such that many applications have similar, redundant functionality. For example, standards exist to describe and negotiate multimedia session between data processing terminals. These negotiations may use various existing and developing protocols such as Session Initiation Protocol (SIP), Session Description Protocol (SDP), and Real Time Streaming Protocol (RTSP). Application developers may include these protocols as part of the application, and for a terminal that only utilizes a single application, this approach may be effective and easy to implement. However, as devices such as mobile terminals gain increased power and bandwidth, a wide range of applications may be required to run from a single device. Having each application negotiate session protocols makes implementing this functionality more difficult and prone to incompatibility. Accordingly, there is a need to enable application developers to easily incorporate multimedia session protocols in their products, particularly in devices and systems where multiple applications access those features.

### SUMMARY OF THE INVENTION

The present disclosure relates to a system, apparatus, and method for providing media session descriptors. In accordance with one embodiment of the present invention, a method of initiating a multimedia session via a computing arrangement involves forming a request for a session descriptor usable for initiating the multimedia session. The request is communicated to a session descriptor module of the computing arrangement. A session descriptor is formed based on a set of multimedia session parameters of the computing arrangement. The session descriptor is communicated from the session descriptor module, and the multimedia session is initiated using the session descriptor.

In accordance with another embodiment of the present invention, a method of joining a multimedia session via a computing arrangement involves receiving a session descriptor describing the multimedia session. The session descriptor is communicated to a session descriptor module of the computing arrangement. The session descriptor is verified based on a set of multimedia session parameters of the computing arrangement. A network connection is established for joining the multimedia session based on the session descriptor, and the multimedia session is joined using the network connection.

In accordance with another embodiment of the present invention a system includes one or more data processing arrangements coupled to a network and adapted to exchange multimedia data via the network. A multimedia processing arrangement is coupled to the network and adapted to establish a multimedia session with the one or more data processing arrangements. The multimedia processing arrangement includes a memory for storing an application and a session descriptor module and a processor coupled to the memory. The processor is operable by the session descriptor module for providing session descriptor data, based on multimedia session parameters of the multimedia processing arrangement. The processor is operable by the application for receiving the session descriptor data and establishing the multimedia session using the session descriptor data.

In more particular embodiments of the invention, the multimedia session descriptors may include a Session Description Protocol (SDP) descriptors. The set of multimedia session parameters may include a Quality of Service (QoS) parameter. The Quality of Service (QoS) parameter may be provided by a QoS module. The set of multimedia session parameters may also include terminal capabilities, terminal or user identity and security information required for initiating the multimedia session. The terminal or user identity, the security information may be provided by a security (e.g. SIM module) or identity module. The set of multimedia session parameters may include a set of codecs, media or device capabilities parameters. The set of codecs, media and device capabilities parameters may be provided by a media or device management module. The session descriptor module may authenticate originators of requests using a Public Key Infrastructure (PKI) key.

### BRIEF DESCRIPTION OF THE DRAWINGS

The invention is described in connection with the embodiments illustrated in the following diagrams.

FIG. 1 illustrates a system environment in which a session descriptor module according to embodiments of the present invention may be employed;

FIG. 2 illustrates a system architecture in which a session descriptor module according to embodiments of the present invention may be employed;

FIG. 3 illustrates a procedure for establishing a multimedia session using a session descriptor module according to embodiments of the present invention;

FIG. 4 illustrates a procedure for joining a multimedia session using a session descriptor module according to embodiments of the present invention;

FIG. 5 illustrates a computing arrangement for processing of multimedia sessions according to embodiments of the present invention; and

FIG. 6 illustrates a mobile terminal for processing of multimedia sessions according to embodiments of the present invention.

### DETAILED DESCRIPTION OF THE INVENTION

In the following description of the example embodiments, reference is made to the accompanying drawings which form a part hereof, and in which is shown by way of illustration various example embodiments in which the invention may be practiced. It is to be understood that other embodiments may be utilized, as structural and operational changes may be made without departing from the scope of the present invention.

Generally, the present disclosure is directed to a system, apparatus, and method of providing session description services using an independent session descriptor module. Other protocol modules can access the session descriptor module for such tasks as defining, initiating, terminating, querying, and modifying various multimedia session parameters. The session descriptor module may provide a complete image of the data session capabilities and device capabilities of an associated data processing arrangement.

The following description may include example implementations of a session descriptor module incorporating the Session Description Protocol (SDP) for purposes of illustration. It will be appreciated by those skilled in the art that the concepts described may be applied to other session descriptor mechanisms, as well as other computer applications where description and negotiation of data session parameters is concerned.

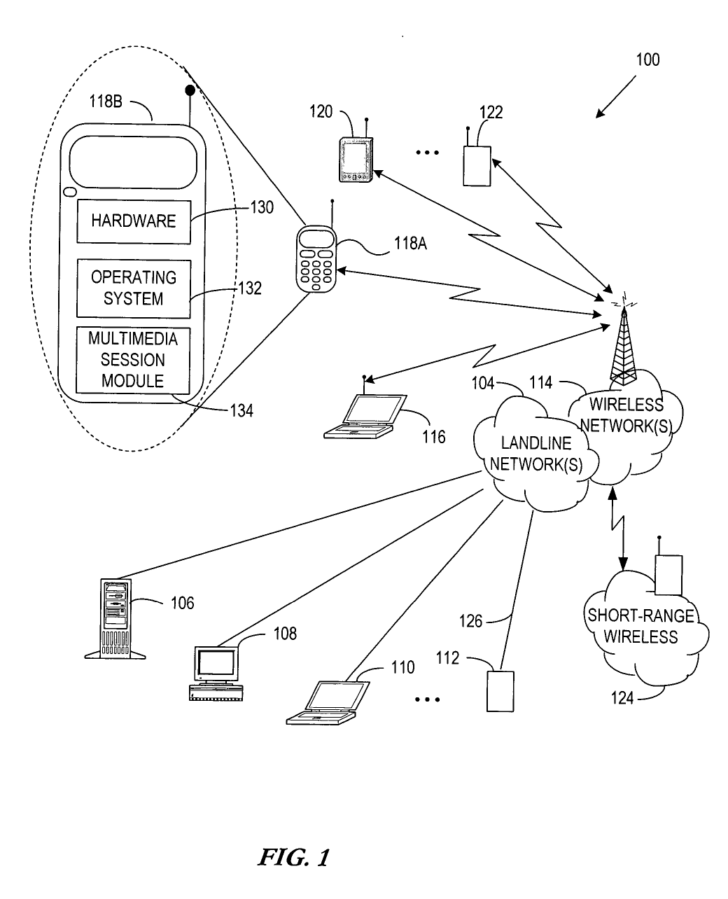

Referring now to FIG. 1, a representative system environment 100 is illustrated in which a session descriptor module may be employed according to embodiments of the present invention. In the representative system environment 100, multimedia sessions may be communicated between target devices in any number of known manners. These manners include via a landline network(s) 104, which may include a Global Area Network (GAN) such as the Internet, one or more Wide Area Networks (WAN), Local Area Networks (LAN), and the like. Any computing device or other electronic device that supports multimedia sessions may be the target system that utilizes the present invention, such as servers 106, desktop computers 108 or workstations, laptop or other portable computers 110, or any other similar computing device capable of communicating via the network 104, as represented by generic device 112.

Multimedia sessions may be communicated via one or more wireless networks 114, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Again, any mobile electronic device that can communicate via multimedia sessions may be a target device that utilizes the invention, such as laptop or other portable computers 116, mobile phones 118A and other mobile communicators, Personal Digital Assistants (PDA) 120, or any other similar computing device capable of communicating via the wireless network 114, as represented by generic device 122.

The multimedia sessions may be established between devices using short-range wireless technologies 124, such as Bluetooth, Wireless Local Area Network (WLAN), infrared (IR), etc. The multimedia sessions may also be established using direct wired connections, such as depicted by connection path 126. The present invention is applicable regardless of the manner in which data is provided or distributed between the target devices.

An example of a target device that utilizes multimedia sessions is illustrated as the mobile terminal 118B. The mobile terminal 118B includes, for example, hardware 130 suitable for executing instructions used for establishing multimedia sessions. The hardware 130 can be coupled to an operating system (OS) 132 that provides hardware access and other services to application software. A session descriptor module 134 provides standalone functionality for providing many multimedia session services. The session descriptor module 134 may be implemented as firmware or as a program running on the OS 130. The session descriptor module 134 may use any combination of multimedia session descriptor protocols known in the art, such as the Session Description Protocol (SDP).

In general, SDP provides a method of conveying information about media streams between potential participants in multimedia sessions and terminal capabilities in general. The purpose of this information is to allow the recipients of a session descriptor to participate in the multimedia session. SDP may be used in many network environments, including ad hoc peer-to-peer networks, LANs, and WANs such as the Internet. SDP describes such parameters as session name and purpose, time window in which the session is active, media, protocols, and formats used during the session, required bandwidth to be used by the session, etc. In general, SDP provide a sufficient set of data for determining whether a network entity is capable of joining in a multimedia session, and enabling the entity to join in the session, if so capable.

A multimedia session may include one or more data streams for delivery of digital content. The communicating of data streams may involve any number of sending and receiving entities, including unicast, multicast, and broadcast data streams. Although the sessions are often described as continuous streams, the sessions may include discrete communications, such as messages or data bursts. Whatever form of the session communication, it is typically understood that the session includes some time of availability (e.g., a beginning and end time) as well as describing data protocols and formats.

The multimedia sessions may include any combination of data transferable via computing arrangements. Multimedia data is typically intended for interpretation by end users, although automated systems may be able to automatically read and interpret some multimedia data without user interaction. Multimedia data may include any combination of text or binary formatted data for transmitting text, sound, video, graphical objects, machine commands, telemetry, etc.

In some implementations, multicast-based sessions allow anyone that can access the data streams to join the session as an active participant. In such an environment, SDP may serve two purposes. First, SDP can be used to communicate the existence of a session. Secondly, SDP can be used to convey information that enables joining and participating in the session. In a unicast environment, only the latter purpose is likely to be relevant. The SDP conveys this information through the use of session descriptors.

An SDP session descriptor can be exchanged via various network and multimedia protocols. An SDP session description includes a number of lines of text of the form <type>=<value>. The <type> field is one character and is case-sensitive. The <value> field is a structured text string of a specific format that depends on<type>. The <value> field is also case-sensitive unless defined otherwise. In general, the <value> field is either a free format string or a number of fields delimited by a single space character.

In general, the functionality required to create and parse SDP descriptors can be embedded within other protocols, such as Session Initiation Protocol (SIP) and Real Time Streaming Protocol (RTSP). This approach may be useful when the system requires only a single, simple protocol stack. However, the existence of multiple SDP parsers can be cumbersome as more applications and protocols utilize SDP.

One problem with using multiple SDP parsers is that version updates may be difficult to apply across the whole system. Separate SDP parsers may also be redundant, and therefore not an efficient use of memory space. Incorporating a single, generic, SDP processing module can provide a centralized, efficient, and easily upgradeable way of providing SDP services.

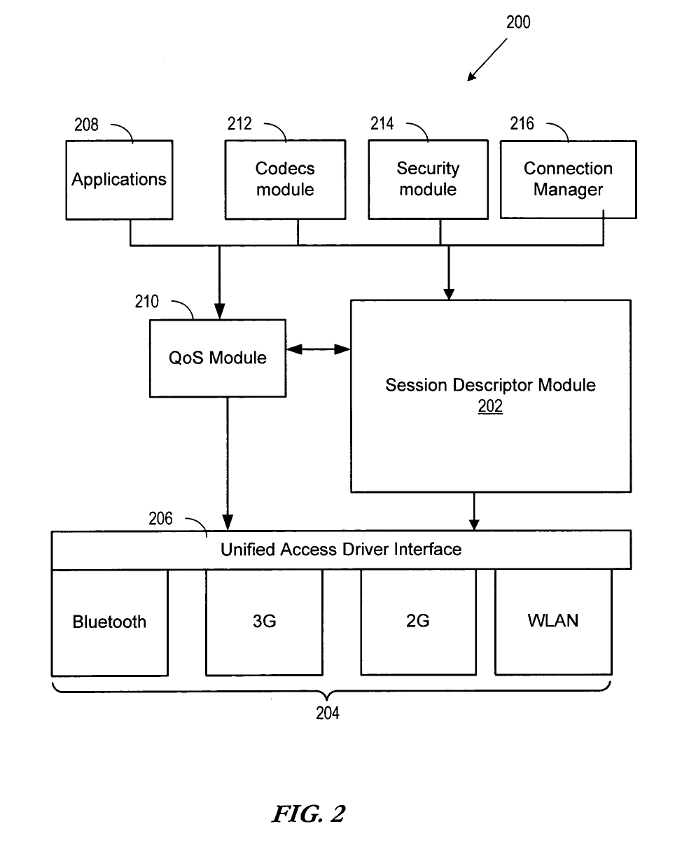

Referring now to FIG. 2, a system architecture 200 with an SDP descriptor module 202 is illustrated according to embodiments of the present invention. The architecture 200 may be applicable to a software architecture for any manner of computing arrangements, including a single device and a distributed computing system. The SDP descriptor module 202 is a functional module that can be used in any architecture that requires session description services. These services may include parsing of incoming SDP descriptors, comparing the capabilities of a device against an SDP descriptor, and providing SDP descriptors for revealing the capabilities of a device.

The SDP descriptor module 202 can be enabled to provide a complete image of capabilities using the SDP protocol. This may involve providing SDP descriptors that allow any application to communicate via SDP. The SDP descriptor module 202 may be able to provide descriptors according to various versions of the SDP protocol to enhance backwards compatibility with older applications and services.

Although the SDP descriptor module 202 can provide descriptors used for establishing multimedia sessions, it will be appreciated that these descriptors may have other uses on the system 200. The SDP descriptor module 202 may provide descriptors of system capabilities such display capabilities (e.g., screen resolution, color depth), audio capabilities (e.g., available hardware, playback codecs), input devices, CPU processing power, CPU extensions or other hardware enhancements (e.g., multimedia instruction sets), a terminal identity (e.g. hostname, network address), device capabilities (e.g. MMS client, e-mail client, SIP client), etc. This type of system information may not necessarily be relevant for session negotiations, but may be used by various applications for discovering device capabilities, configurations or profiles.

The SDP descriptor module 202 may require interactions with other functional modules of the architecture 200 in order to collect and maintain system capabilities information. Because SDP deals with multimedia sessions, one commonly described set of capabilities relates to network communications. An important source of network information comes through the system hardware and drivers that interact with the hardware.

The architecture 200 may include a set of drivers 204 for various hardware configurations and communications protocols. In the illustrated example, the drivers 204 can be accessed directly, or via a unified access driver interface 206. The unified access driver interface 206 can be used to abstract common access functionality related to the drivers 204. The use of a unified access driver interface 206 can simplify the implementation of software modules that need access to the drivers 204.

One network parameter sometimes utilized by multimedia applications is quality of service (QoS). The QoS is a function of network data transfer performance (bandwidth, latency, etc.). The architecture 200 may include applications 208 that process data streams and require a minimum level of QoS for effective performance. Applications 208 that require specific QoS levels may need to negotiate these requirements with the network connections. In the illustrated example, a QoS module 210 is provided to assist in negotiating these requirements. In general, the QoS module 210 is a functional unit that can act as an intermediary between the applications 208 and drivers 204 to provide network connections having a desired QoS.

In some cases, joining a multimedia session may require some level of guaranteed network QoS. The SDP module 202 may interface with the QoS module 210 to query regarding QoS availability, as well as for initiating the session using the requested QoS. The communications between the SDP module 202 and the QoS module 210 may be in response to user initiated events (e.g., request to join a session) and network events (e.g., change in bearer and/or QoS availability). If the QoS module 210 cannot provide all required bearer information, then the SDP module 202 may be configured to obtain this information directly from the drivers, 204, driver interface 206 or any other module in the system.

Another important parameter associated with multimedia session is the format and coding of data streams. A codecs module 212 may be included in the architecture for accessing and maintaining various multimedia codecs. The codecs module 212 may be used by applications 208 for decoding data streams. Similarly, the SDP module 202 can access the codecs module 212 for such information as default codecs or the availability of a given codec usable for joining in an advertised multimedia session.

Often multimedia sessions require security features such as authentication and encryption. This functionality may reside in a security module 214. The SDP module 202 may use the security module 214 for such tasks as encrypting the SDP descriptors when such encryption is required by the session. The security module 214 may also be used in conjunction with the SDP module 202 to request the session specific security credentials. Those credentials are included in the SDP message so the device utilizes those credentials for encrypting the media exchange. The security module 214 may be used in conjunction with the SDP module 202 when authenticating multimedia data such as identities of users and applications requesting terminal information. For example, an application 206 that requests terminal information may first have to provide Public Key Infrastructure (PKI) data to authenticate the application's authenticity and privileges. In most cases, a PKI authentication key is stored when software is first downloaded and installed on a terminal. Using PKI authentication data when accessing the SDP module 202 can prevent the disclosure of terminal data to untrusted applications and/or viruses.

When initiating, advertising, or otherwise interacting with multimedia sessions, the applications 208 may interface with the SDP module 202 directly. In other arrangements, the services of the SDP module 202 may be accessed through a higher level abstraction, such as a connection manager 216. The connection manager 216 may be any system library, application, or process that handles the details of interacting with multimedia connections. The applications 208 may simply incorporate calls to the connection manager 216 for some or all connection oriented tasks, such as initiating connections, selecting parameters (codecs, security, bearers, protocols, etc.), and providing a user interface for actions that require human intervention.

In general, any software that requires the uses of SDP in dealing with multimedia sessions can utilize the SDP module 202. For example, an end user application 208 may require a description of the system capabilities related to multimedia data sessions. The application 208 can request a description of these capabilities from the SDP module 202. The descriptions received from the SDP module 202 can be provided as programmatic data entities such as structures or objects. The SDP module 202 may also provide descriptions using a textual format, such as an SDP header or an XML document that encapsulates an alternate form of SDP known as “SDPng.” The request for descriptions can be made directly to the SDP module 202, or indirectly, such as via the connection manager 216.

In response to the request, the SDP module 202 can query other functional modules such as the QoS module 210 and codecs module 212 for current conditions regarding the data transfer capabilities of the system 200. The SDP module 202 may contact other functional modules each time a request is received by the SDP module 202. In other arrangements, the SDP module 202 may cache this information and update the cache by requesting that the other functional modules sent update events that reflect change in capabilities. For example, the SDP module 202 may initially query the QoS module 210 regarding available QoS, and store this in the cache. If the QoS changes, the QoS module 210 can send an event to the SDP module 202, and the SDP module then updates the cache. These update events may be in the form of triggers, registered callbacks, messages, and/or any manner of inter-process communication (IPC) mechanisms.

The application 208 that is requesting session data from the SDP module 202 may also require updates due to asynchronous changes in data transfer capabilities. For example, the application 208 may require knowledge of data stream changes (e.g., codec, compression level, and resolution) in order to provide uninterrupted service if QoS levels change. The application 208 may request these updates be received as events from the QoS module 210. If the application 208 receives update events from the QoS module 210 (or other relevant functional modules), the application 208 can then request a new snapshot of system capabilities via the SDP module 202.

In an alternate arrangement, the application 208 may request system capability updates in be received from the SDP module 202. In this arrangement, the SDP module 202 listens for and receives update events, and then passes those events to the application 208 via SDP data structures. In a similar arrangement, the updates may be gathered and propagated by another system component, such as the connection manager 216. The connection manager 216 may provide updates to the application using SDP data structures, or by its own particular data structures. In general, tracking system connection states by a module outside the application 208 can make application development easier. However, allowing the application 208 to register for any system events with the functional modules provides more flexibility and allows the application to focus on only those events of interest.

Another example of SDP module 202 interactions within the system 200 involves security. The system may include a PKI key usable for downloading and installing new software on the system 200. This and other PKI keys may be managed and securely stored via the security module 214. When an application 208 requests data from the SDP module 202, there may be a policy that the application 208 be authenticated depending on the granularity and confidentiality of the requested data.

The SDP module 202 may also require secure communications between other function modules on the system 200. The SDP module 202 may use a secure channel with the security module 202 when requesting credentials, thereby preventing the credentials and other sensitive data from being detected or intercepted via system software or hardware.

The SDP module 202 may require the ability to provide encrypted SDP headers. This encryption may be requested by the application 208 using the SDP data. The capability to encrypt SDP headers may be included in the SDP module 202, or may be accessed via another module, such as the security module 214. In addition, the SDP description itself may include PKI keys or other security related data usable for initiating sessions. For example, the data streams may be encrypted using a PKI scheme, and therefore the SDP descriptor may include public keys usable by participants for decrypting the data stream.

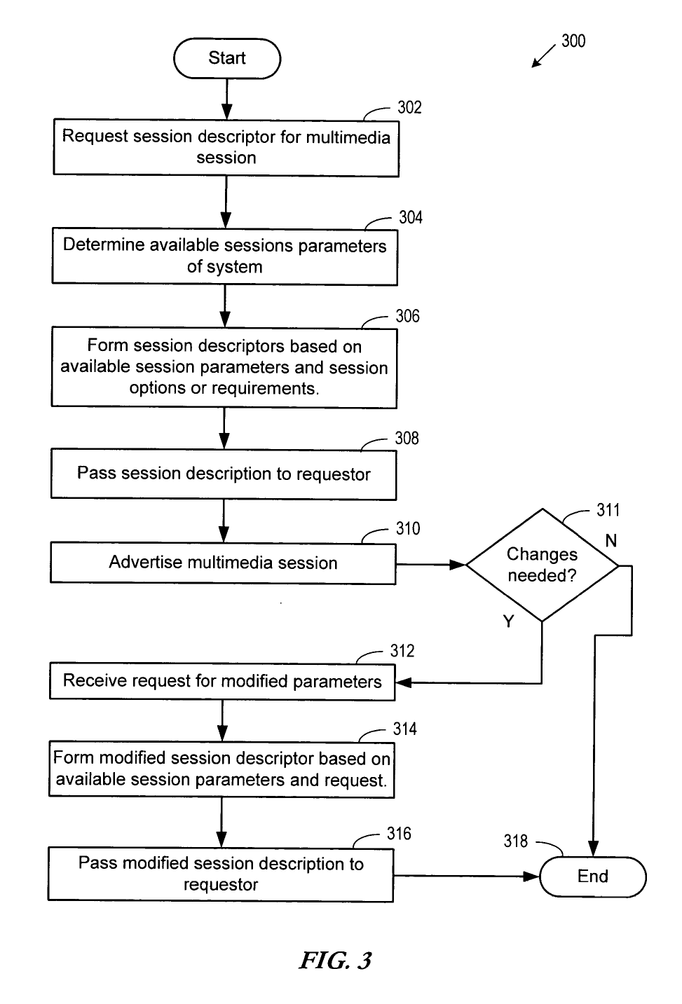

A session descriptor module may be useful in both advertising multimedia sessions originating at a computing arrangement and in determining whether a computing arrangement has the capability to join to an existing multimedia session. An example of how a session description module might interact to advertise a session is illustrated in FIG. 3. A flowchart 300 in FIG. 3 illustrates interactions that take place between a session descriptor module and other functional modules according to embodiments of the present invention.

The procedure illustrated in FIG. 3 begins when a user (or any system agent) requests (302) a session descriptor used to advertise a multimedia session. For example, the user could wish to advertise a video teleconference with one or more other networked users. The video teleconference could include a video stream and a telemetry stream used by a whiteboard program for drawing sketches. Based on the request (302), the system can determine (304) the available capabilities of the system needed to establish the session. This determination (304) may occur by an application working communicating with a session descriptor module, or some sort of system session controller such as a connection manager. For example, an application can provide broad categorical description of a parameter (e.g., video codec) and the descriptor module could use this to query the system for specific parameters available on the system (e.g., MPEG-4, H.261).

In this example, the determination (304) may include gathering such data categories as network bearers, QoS, video/audio codecs, whiteboard protocols, floor control protocols, etc., that are available on the system for establishing a video and whiteboard conference. The determination (304) may require user input, as there may be some costs associated with different types and levels of service. Of course, there may be multiple specific session parameters available, and the system may only include subset of the specific parameters when proceeding to form (306) the session descriptor.

A subset of session parameters may be used to form (306) a session descriptor. The subset of parameters may be chosen by such means as system defaults, user selections, or negotiations with other entities to achieve compatibility amongst session participants. Once formed (306), the session descriptor can be passed (308) to the requester using any combination of data arrangements (e.g., binary object, SDP header, etc.). The requestor can advertise (310) the multimedia session with the session descriptor.

Assuming that the session is joined and proceeds normally, no changes are needed (311) and the session descriptor module's work may be complete (318). However, it may be that in order to join a session, an invitee needs to choose from a set of offered session parameters or try to choose another parameter. Similarly, an in-progress session may need session parameters renegotiated, due to such events as network problems or change in network bearers. In this case, a change is needed (311) and a user or software component of the system may request (312) modified session parameters.

The request (312) for modified parameters may include further limitations on one or more session parameters, such as a different QoS due to network conditions. The session descriptor module can form (314) a modified session descriptor based on the request and pass (316) to the requester.

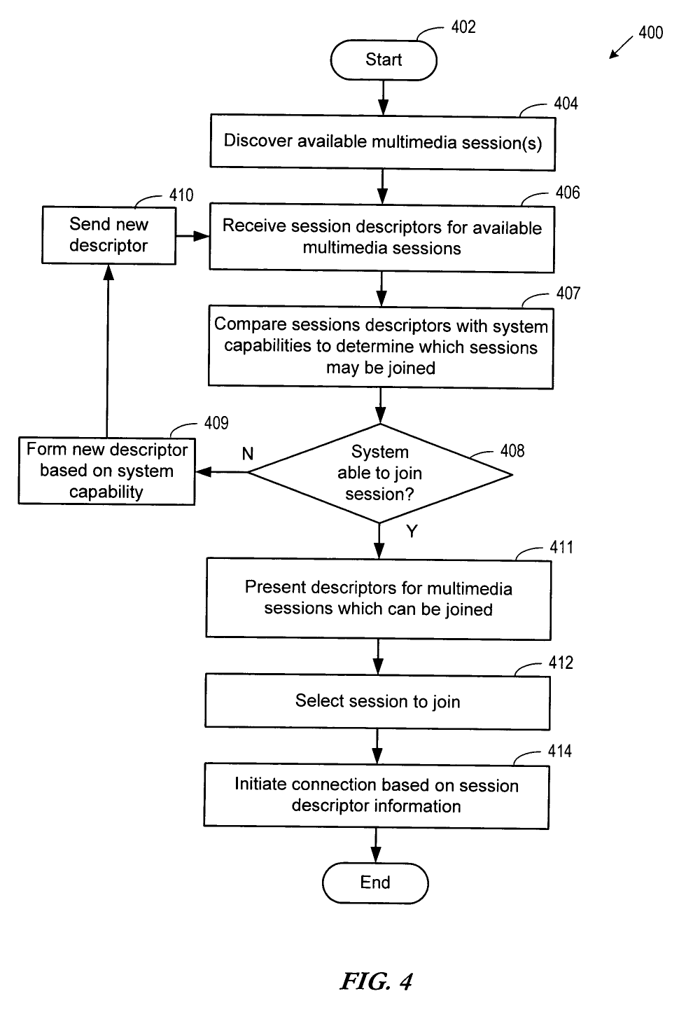

Another application of session descriptors relates to examining incoming requests for multimedia sessions, as well as the discovery of and joining existing sessions. The flowchart 400 of FIG. 4 illustrates one example of a how a system utilizing a session descriptor module may handle these situations. The procedure begins (402) with a discovery (404) of one or more available multimedia sessions. This discovery (404) may, for example, be the result of an incoming request to join a session. In another scenario, the discovery (404) may be an automated or user-initiated request to find currently active broadcast or multicast sessions.

Once the sessions have been discovered (404), the system may receive (406) session descriptors of the sessions in any manner known in the art. The session descriptors may be received (406) by the application, the session descriptor module, or another functional/protocol module. For example, the session descriptor may be included in a Session Initiation Protocol (SIP) header. An application or SIP protocol module may be able to strip out the SDP headers and send them to the session description module.

The session description module can compare (407) any received descriptors against system capabilities. This comparison (407) may involve simply providing a yes/no decision (408) to whether the session can be joined, or the comparison (407) may be a starting point for negotiating session parameters between two or more entities. In some cases, the received session descriptor may include multiple capability parameters, and a choice of one parameter must be made by the receiving system. In other situations, the receiving system may request a change to one or more session description parameters from those listed in the received descriptor. In situations such as this, the system may decide (408) that further negotiation is required.

The session descriptor module can be configured with functionality usable for negotiating the session parameters, including parsing the incoming session descriptors and comparing (407) the media capabilities from the remote device versus the local media capabilities. If the session descriptor module decides (408) that further negotiation is needed, it can form (409) a new session descriptor based on the received descriptor and system capabilities. This new session descriptor can be sent (410) to the originator of the descriptor. This negotiation may continue with the receipt (406) of session descriptors from the other entities based on the sent descriptor.

Using a session descriptor module can free multimedia applications and other system modules from having to provide logic related to system capabilities and session description protocols (e.g., SDP). The application only needs to receive (406) the session descriptor and pass the descriptor to the session descriptor module. The session descriptor module can parse, process and create (409) the new session descriptor, and send it to the application to be used for further negotiation. The negotiations are complete when the session descriptor module decides (408) the system can join the session depicted by the current descriptor.

If the application is involved in discovering multiple sessions to join, session descriptors representing joinable sessions may be presented (411) by the session descriptor module. It may be that the system was incapable of joining any sessions, therefore the session descriptor module may present (411) an empty list. The session descriptors may be used for selecting (412) sessions to be joined (414). If the session is a unicast or point-to-point session, the presentation (411) and selection (412) may not be required, and the system may proceed to join (414) the session.

Of course, it will be appreciated that the procedures detailed in FIGS. 3 and 4 are only example implementations of session descriptor functionality that may be included in a computing arrangements according to embodiments of the present invention. The procedures 300, 400 may be adapted to use alternate steps and sequences, as well as adapted for accomplishing other multimedia session description tasks known in the art.

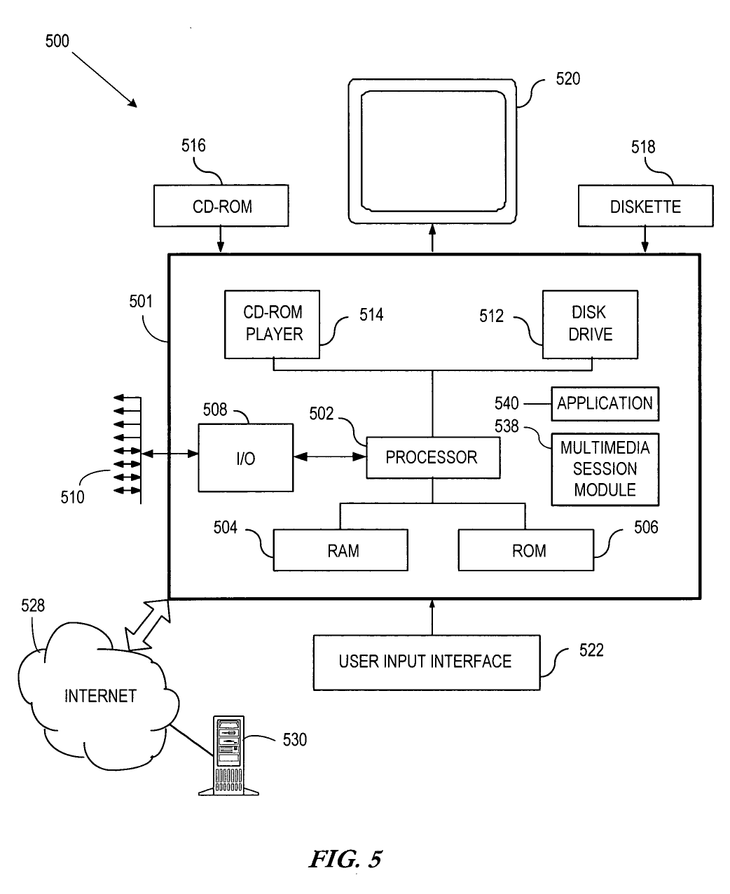

Referring now to FIG. 5, an example computing structure 500 is shown that is suitable for providing session description functionality in accordance with embodiments of the present invention. The computing structure 500 includes a computing arrangement 501. The computing arrangement 501 may act a peer, client, server, gateway, proxy, or any other network entity used for providing or joining in multimedia sessions. The computing arrangement 501 includes a central processor (CPU) 502 coupled to random access memory (RAM) 504 and read-only memory (ROM) 506. The ROM 506 may also be other types of storage media to store programs, such as programmable ROM (PROM), erasable PROM (EPROM), etc. The processor 502 carries out a variety of functions as is known in the art, as dictated by software and/or firmware instructions. The processor 502 may communicate with other internal and external components through input/output (I/O) circuitry 508 and bussing 510, to provide control signals and the like. For example, processing of requests for session descriptors may be performed by the computing arrangement 501 at a session descriptor module 538. The session descriptor module 538 can communicate with an application 540 that communicates using network media sessions.

External data storage devices, such as databases, used for accessing session descriptor data, may be coupled to I/O circuitry 508 to facilitate session description functions as described hereinabove. Alternatively, such databases may be locally stored in the storage/memory of the server 501, or otherwise accessible via a local network or networks having a more extensive reach such as the Internet 528.

The computing arrangement 501 may also include one or more data storage devices, including hard and floppy disk drives 512, CD-ROM drives 514, and other hardware capable of reading and/or storing information such as DVD, etc. In one embodiment, software for carrying out session description module operations in accordance with the present invention may be stored and distributed on a CD-ROM 516, diskette 518 or other form of media capable of portably storing information. These storage media may be inserted into, and read by, devices such as the CD-ROM drive 514, the disk drive 512, etc. The software may also be transmitted to computing arrangement 501 via data signals, such as being downloaded electronically via a network, such as the Internet 528. The computing arrangement 501 may be coupled to a display 520, which may be any type of known display or presentation screen, such as LCD displays, plasma display, cathode ray tubes (CRT), etc. A user-input interface 522 may be provided, including one or more user interface mechanisms such as a mouse, keyboard, microphone, touch pad, touch screen, voice-recognition system, etc.

The computing arrangement 501 may be coupled to other computing devices, such as landline and/or wireless terminals via a network, for Web service messaging. The server may be part of a larger network configuration as in a global area network (GAN) such as the Internet 528, which allows connections to the various landline and/or mobile devices.

The capability to engage in multimedia sessions can be advantageous when included in any data processing device known in the art, including mobile devices. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the multimedia session functionality as described herein. Hardware, firmware, software or a combination thereof may be used to perform the various session descriptor functions described herein.

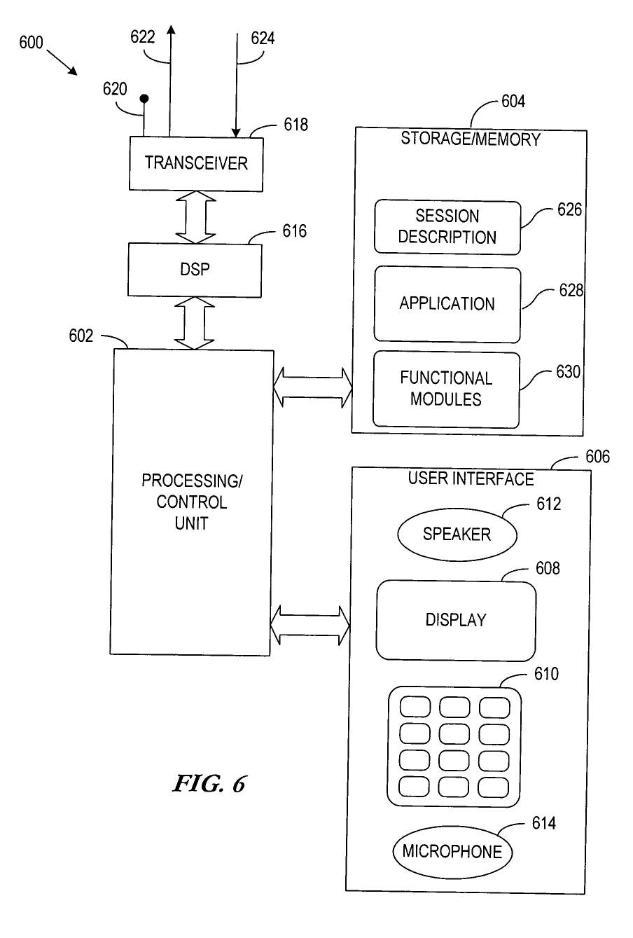

An example of a representative mobile terminal computing system capable of carrying out operations in accordance with the invention is illustrated in FIG. 6. Those skilled in the art will appreciate that the exemplary mobile computing environment 600 is merely representative of general functions that may be associated with such mobile devices, and also that landline computing systems similarly include computing circuitry to perform such operations.

The mobile computing arrangement 600 is suitable for processing multimedia session descriptions in accordance with embodiments of the present invention. The representative mobile computing arrangement 600 includes a processing/control unit 602, such as a microprocessor, reduced instruction set computer (RISC), or other central processing module. The processing unit 602 need not be a single device, and may include one or more processors. For example, the processing unit may include a master processor and associated slave processors coupled to communicate with the master processor.

The processing unit 602 controls the basic functions of the mobile terminal, and also those functions associated with the present invention as dictated by the session description module 626 and an application 628 available in the program storage/memory 604. Thus, the processing unit 602 may be capable of interfacing with multimedia session using the session description module 626 and/or the application 628. The application 628 and session description module 626 may also be arranged to interface with any other functional modules 630 that may deal with multimedia sessions, such as QoS or security modules.

The program storage/memory 604 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 604 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 600 via data signals, such as being downloaded electronically via one or more networks, such as the Internet and an intermediate wireless network(s).

The processor 602 is also coupled to user-interface 606 elements associated with the mobile terminal. The user-interface 606 of the mobile terminal may include, for example, a display 608 such as a liquid crystal display, a keypad 610, speaker 612, and microphone 614. These and other user-interface components are coupled to the processor 602 as is known in the art. Other user-interface mechanisms may be employed, such as voice commands, switches, touch pad/screen, graphical user interface using a pointing device, trackball, joystick, or any other user interface mechanism.

The mobile computing arrangement 600 also includes conventional circuitry for performing wireless transmissions. A digital signal processor (DSP) 616 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 618, generally coupled to an antenna 620, transmits the outgoing radio signals 622 and receives the incoming radio signals 624 associated with the wireless device.

The mobile computing arrangement 600 of FIG. 6 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc.

Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a system, apparatus, and method in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method of initiating a multimedia session via a computing arrangement, comprising:
forming a request for a session descriptor usable for initiating the multimedia session;
communicating the request to a session descriptor module of the computing arrangement;
forming a session descriptor based on a set of multimedia session parameters of the computing arrangement;
communicating the session descriptor from the session descriptor module; and
initiating the multimedia session using the session descriptor.

2. The method according to claim 1, wherein the session descriptor comprises a Session Description Protocol (SDP) descriptor.

3. The method according to claim 1, wherein the set of multimedia session parameters includes a Quality of Service (QoS) parameter, and wherein forming the session descriptor further comprises receiving the Quality of Service (QoS) parameter from a QoS module of the computing arrangement.

4. The method according to claim 1, wherein the set of multimedia session parameters includes a session security parameter, and wherein forming the session descriptor further comprises receiving the session security parameter from a security module of the computing arrangement.

5. The method according to claim 1, wherein the set of multimedia session parameters includes a media codecs parameter, and wherein forming the session descriptor further comprises receiving the media codecs parameter from a codecs module of the computing arrangement.

6. The method according to claim 1, wherein the set of multimedia session parameters includes a device description parameter, and wherein forming the session descriptor further comprises receiving the device description parameter from a device management module of the computing arrangement.

7. The method according to claim 1, further comprising authenticating an originator of the request using an identity parameter.

8. The method according to claim 7, wherein the identity parameter comprises a Public Key Infrastructure (PKI) key.

9. The method according to claim 7, wherein authenticating the originator of the request comprises authenticating the originator of the request via a security module of the computing arrangement.

10. The method according to claim 1, wherein forming the session descriptor further comprises encrypting the session descriptor.

11. The method according to claim 1, further comprising:
detecting an update in a system parameter that affects the multimedia session;
forming a modified session descriptor based on the update; and
communicating the modified session descriptor from the session descriptor module.

12. A system, comprising:
one or more data processing arrangements coupled to a network and adapted to exchange multimedia data via the network;
a multimedia processing arrangement coupled to the network and adapted to establish a multimedia session with the one or more data processing arrangements, the multimedia processing arrangement comprising:
a memory for storing an application and a session descriptor module; and
a processor coupled to the memory, the processor operable by the session descriptor module for providing session descriptor data based on multimedia session parameters of the multimedia processing arrangement, the processor operable by the application for receiving the session descriptor data and establishing the multimedia session using the session descriptor data.

13. The messaging system according to claim 12, wherein the session descriptor data comprises a Session Description Protocol (SDP) descriptor.

14. The messaging system according to claim 12, wherein the memory is arranged to store a Quality of Service (QoS) module, and the processor is operable by the QoS module for providing a QoS parameter to the session descriptor module usable for forming the session descriptor data.

15. The messaging system according to claim 12, wherein the memory is arranged to store a security module, and the processor is operable by the security module for providing an authentication to the session descriptor module usable for authenticating a permission of the application to receive the session descriptor data.

16. The messaging system according to claim 12, wherein the memory is arranged to store a security module, and the processor is operable by the security module for encrypting the session descriptor data provided by the session descriptor module.

17. A mobile terminal wirelessly coupled to a network, comprising:
a transceiver configured to facilitate exchange of multimedia data via the network;
a memory capable of storing at least one of a session descriptor module and a multimedia application; and
a processor coupled to the memory and operable by the multimedia application to establish a multimedia session via the network, the processor operable by the session descriptor module to:
receive a request for a multimedia session descriptor;
determine a set of multimedia parameters of the mobile terminal;
form the multimedia session descriptor based on the set of multimedia parameters of the mobile terminal, the multimedia descriptor usable in establishing the multimedia session; and
communicate the multimedia session descriptor to enable establishment of the multimedia session by the multimedia application.

18. The mobile terminal according to claim 17, wherein the multimedia session descriptor include a Session Description Protocol (SDP) descriptor.

19. The mobile terminal according to claim 17, wherein the memory is further capable of storing a Quality of Service (QoS) module, and the processor is operable by the QoS module for providing a QoS parameter to the session descriptor module usable for forming the session descriptor data.

20. The mobile terminal according to claim 17, wherein the memory is further capable of storing a security module, and the processor is operable by the security module for providing an authentication to the session descriptor module usable for authenticating a permission of the application to receive the session descriptor data.

21. The mobile terminal according to claim 17, wherein the memory is further capable of storing a security module, and the processor is operable by the security module for encrypting the session descriptor data provided by the session descriptor module.

22. A computer-readable medium having instructions stored thereon which are executable by a computing arrangement for establishing a multimedia session via a network by performing steps comprising:
receiving a request for a session description usable for establishing the multimedia session;
determining a set of system parameters affecting the establishment of the multimedia session at a session descriptor module in response to the request;
forming the session descriptor at the session descriptor module, the session descriptor used for establishing the multimedia session;
communicating the session descriptor from the session descriptor module to enable establishment of the multimedia session; and
initiating the multimedia session via a multimedia application using the session descriptor.

23. The computer readable medium according to claim 22, wherein the session descriptor comprises a Session Description Protocol (SDP) descriptor.

24. The computer readable medium according to claim 22, wherein determining the set of system parameters comprises receiving a Quality of Service (QoS) parameter from a QoS module of the computing arrangement.

25. The computer readable medium according to claim 22, further comprising authenticating an originator of the request using a Public Key Infrastructure (PKI) key.

26. A method of joining a multimedia session via a computing arrangement, comprising:
receiving a session descriptor describing the multimedia session;
communicating the session descriptor to a session descriptor module of the computing arrangement;
verifying the session descriptor based on a set of multimedia session parameters of the computing arrangement;
establishing a network connection for joining the multimedia session based on the session descriptor; and
joining the multimedia session using the network connection.

27. The method according to claim 26, wherein the session descriptor comprises a Session Description Protocol (SDP) descriptor.

28. The method according to claim 26, wherein the set of multimedia session parameters includes a Quality of Service (QoS) parameter, and wherein verifying the session descriptor further comprises receiving the Quality of Service (QoS) parameter from a QoS module of the computing arrangement.

29. The method according to claim 26, wherein verifying the session descriptor comprises authenticating the originator of the session descriptor via a security module.

30. A method of providing a multimedia session via a computing arrangement, comprising:
forming a request for a multimedia configuration descriptor that describes multimedia capabilities of the computing arrangement;
communicating the request to a session descriptor module of the computing arrangement;
forming the multimedia configuration descriptor based on the multimedia capabilities the computing arrangement;
communicating the multimedia configuration descriptor from the session descriptor module; and
establishing the multimedia session using the multimedia configuration descriptor.

31. The method according to claim 30, wherein the multimedia configuration descriptor includes a session security descriptor, and wherein forming the multimedia configuration descriptor further comprises receiving the session security descriptor via a security module of the computing arrangement.

32. The method according to claim 30, wherein the multimedia configuration descriptor includes a media codecs descriptor, and wherein forming the multimedia configuration descriptor further comprises receiving the media codecs descriptor from a codecs module of the computing arrangement.
